(19) United States
(12) Patent Application Publication
(10) Pub. No.: US 2026/0128235 A1
(43) Pub. Date: May 7, 2026

(54) CONSOLIDATED POWDER ALUMINUM ELECTROLYTIC CAPACITOR FOR SEMICONDUCTOR DEVICE

(71) Applicant: Saras Micro Devices, Inc., Chandler, AZ (US)

(72) Inventor: Michael Randall, Simpsonville, SC (US)

(21) Appl. No.: 18/940,400

(22) Filed: Nov. 7, 2024

(51) Int. Cl. H01G 9/00; H01G 9/055; H01G 2/06

(52) U.S. Cl. CPC H01G 9/0036; H01G 9/0032; H01G 9/055; H01G 2/06

(57) ABSTRACT

A method of manufacturing an aluminum electrolytic capacitor for a semiconductor device may include consolidating aluminum powder into a porous pellet, sintering the porous pellet, etching the porous pellet to increase a surface area thereof, anodizing the porous pellet to form an aluminum oxide dielectric layer on the etched porous pellet, and providing a conductive polymer layer on the aluminum oxide dielectric layer. The aluminum electrolytic capacitor may be surface mounted or may be embedded in an interposer or a package substrate of the semiconductor device or in a circuit board.

### BACKGROUND

Current chip-type and/or embedded aluminum electrolytic (AE) conductive polymer (CP) capacitors utilize aluminum foil that has been etched in order to increase surface area, and thus active area A, and accordingly capacitance per unit volume C/Vol. and capacitance per unit weight or mass (C/g, (gram)). Multiple etched aluminum foil sub-elements (or leafs) may be used in a stacked configuration to further increase A, and thus C/Vol. as well as C/g. This has been successful in enabling capacitance as high as 220 μF in a 7343-20 case size (i.e., metric case size of 7.3 mm length x 4.3 mm width x 2.0 mm thickness) with 6.3 V_{rated}, or about 3,500 μF per cm³ in packaged device form. However, this type of design leaves a large amount of inactive volume, with the active portion of the capacitor estimated to be less than 15% by volume in the case of the 7343-20 metric 220 μF 6.3 V_{rated} capacitor.

The conventional stacking approach has other issues as well. Accurate stacked construction of the delicate foil leafs is complicated in comparison to other capacitor manufacturing methods such as those used to produce pressed tantalum or niobium powder pellets, leading to extra expense as well as quality and yield challenges. Because of this, AE CP capacitors tend to be expensive, i.e., about a third more expensive than their associated tantalum CP (conductive polymer) analogs per unit capacitance, despite bulk aluminum being _{≲}1/70th the cost of bulk tantalum. Unfortunately, tantalum CP capacitors are not a suitable replacement for AE CP capacitors because of the higher resistivity of tantalum, resulting in higher equivalent series resistance (ESR) of the capacitor. Additionally, Ta at 16.65 g/cm³ is more than 6 times the density of Al (2.70 g/cm³), resulting in capacitor devices that are unnecessarily high in C/g. Thus, pressed tantalum and niobium powder pellets do not achieve as high of a surface area per unit mass as stacked AE capacitors, limiting active area A and thus C/g.

### BRIEF SUMMARY

The present disclosure contemplates various devices and methods for overcoming drawbacks accompanying the related art. One aspect of the embodiments of the present disclosure is a method of manufacturing an aluminum electrolytic capacitor for a semiconductor device. The method may comprise consolidating aluminum powder into a porous pellet, sintering the porous pellet, etching the porous pellet to increase a surface area thereof, anodizing the porous pellet to form an aluminum oxide dielectric layer on the etched porous pellet, and providing a conductive polymer layer on the aluminum oxide dielectric layer.

Another aspect of the embodiments of the present disclosure is a method of manufacturing an aluminum electrolytic capacitor for a semiconductor device. The method may comprise consolidating aluminum powder into a porous pellet, sintering the porous pellet, etching the porous pellet to increase a surface area thereof, anodizing the porous pellet to form an aluminum oxide dielectric layer on the etched porous pellet, providing a conductive polymer layer on the aluminum oxide dielectric layer to form the aluminum electrolytic capacitor having the etched porous pellet as an anode and having the conductive polymer layer as a cathode, and embedding the aluminum electrolytic capacitor in an interposer or a package substrate of the semiconductor device.

Another aspect of the embodiments of the present disclosure is a method of manufacturing an aluminum electrolytic capacitor for a semiconductor device. The method may comprise consolidating aluminum powder into a porous pellet, sintering the porous pellet, etching the porous pellet to increase a surface area thereof, anodizing the porous pellet to form an aluminum oxide dielectric layer on the etched porous pellet, providing a conductive polymer layer on the aluminum oxide dielectric layer to form the aluminum electrolytic capacitor having the etched porous pellet as an anode and having the conductive polymer layer as a cathode, and embedding the aluminum electrolytic capacitor in a circuit board.

The method of any of the above aspects may comprise inserting a conductive lead into the porous pellet prior to sintering, or attaching a conductive lead to the porous pellet after sintering by way of spot welding, laser welding or the like. The conductive lead may be inserted prior to consolidating the aluminum powder. The method may comprise providing a conductive carbonaceous layer on the conductive polymer layer. The method may comprise providing a metallization layer on the conductive carbonaceous layer. The porous pellet may have a packing factor of 15%-93%, preferably 25%-80%, more preferably 35%-60%. The method may comprise mixing the aluminum powder with a binder prior to consolidating the aluminum powder. The method may comprise removing organic material from the porous pellet by thermal processing. The sintering may be performed in a reducing sintering atmosphere to control oxidation of the aluminum. The sintering may be performed in a non-oxidizing atmosphere. The sintering may be performed with a maximum thermal processing temperature below a melting point of the aluminum powder. The sintering may be performed with a maximum thermal processing temperature of 280 ºC to 655 ºC, preferably 300 ºC to 650 ºC, more preferably 315 ºC to 635 ºC. The etching may increase the surface area by a factor of at least 2, preferably at least 10, more preferably at least 100. The etching may comprise electrochemical etching, chemical etching, or a combination of electrochemical etching and chemical etching. Providing the conductive polymer layer may comprise dipping the etched porous pellet with the aluminum oxide dielectric layer into conductive polymer precursor.

Another aspect of the embodiments of the present disclosure is an electrolytic capacitor. The electrolytic capacitor may have an anode formed from a consolidated powder pellet having accessible open pore surface area ≥1.6 m²/cm³ and comprising an aluminum containing valve metal that has been anodized to form a dielectric coating thereon.

The consolidated powder may comprise one or more of spherical, spheroidal, granular, nodular, irregular, flake, acicular, or fibrillar shaped powder(s) or the like. The consolidated powder pellet may be formed by one or more of rolling, casting, extruding, pressing, or thick film deposition or the like. The consolidated powder pellet may be formed by thermal treatment, which may be performed at least partially in a neutral or reducing gas atmosphere. The maximum thermal treatment temperature may be between 250 ºC and 655 ºC. The accessible open pore surface area may be achieved at least partially by etching, which may be performed chemically and/or electrochemically. Electrochemical formation may be achieved using direct current, alternating current, and/or pulsed current. The aluminum containing valve metal may be ≥99% purity Al, preferably ≥99.5% purity Al. The aluminum containing valve metal may substantially have a cubic crystal structure. The capacitor counter electrode or cathode may comprise one or more conductive polymer(s). The capacitance of the electrolytic capacitor may exceed 220 μF in a 7343-20 case size and may exceed 3,500 μF/cm³.

Another aspect of the embodiments of the present disclosure is an aluminum solid electrolyte capacitor having capacitance per unit volume of at least 3,500 μF/cm³.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows an aluminum electrolytic capacitor configured as a surface mount device;

FIG. 2 shows a process of manufacturing an aluminum electrolytic capacitor in accordance with an embodiment of the disclosed subject matter;

FIG. 3 shows a stage of the process;

FIG. 4 shows another stage of the process;

FIG. 4A is a closeup view of a portion of FIG. 4;

FIG. 5 shows another stage of the process;

FIG. 5A is a closeup view of a portion of FIG. 5;

FIG. 6 shows another stage of the process;

FIG. 6A is a closeup view of a portion of FIG. 6;

FIG. 7 shows another stage of the process;

FIG. 7A is a closeup view of a portion of FIG. 7;

FIG. 8 shows another stage of the process;

FIG. 8A is a closeup view of a portion of FIG. 8;

FIG. 9 shows another stage of the process;

FIG. 10 shows another stage of the process;

FIG. 11 shows an aluminum electrolytic capacitor configured as an embedded device;

FIG. 12 shows an aluminum electrolytic capacitor configured as a multilayer device;

FIG. 13 shows an aluminum electrolytic capacitor configured as another multilayer device;

FIG. 14 shows an aluminum electrolytic capacitor configured as another multilayer device;

FIG. 15 shows an aluminum electrolytic capacitor configured as another multilayer device;

FIG. 16 shows a stage of a process for manufacturing an array of an aluminum electrolytic capacitors;

FIG. 17 shows another stage of the process;

FIG. 18 shows another stage of the process;

FIG. 19 shows another stage of the process;

FIG. 20 shows another stage of the process;

FIG. 21 shows another stage of the process;

FIG. 22 shows another stage of the process;

FIG. 23 shows another stage of the process;

FIG. 24 shows another stage of the process;

FIG. 25 shows another stage of the process;

FIG. 26 shows another stage of the process;

FIG. 27 shows another stage of the process; and

FIG. 28 shows an aluminum electrolytic capacitor singulated from the array of capacitors.

### DETAILED DESCRIPTION

The present disclosure encompasses various embodiments of methods of manufacturing aluminum electrolytic capacitors to be embedded in a package substrate or interposer of a semiconductor device or a circuit board or to be surface mounted, along with the resulting devices. The detailed description set forth below in connection with the appended drawings is intended as a description of several currently contemplated embodiments and is not intended to represent the only form in which the disclosed subject matter may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

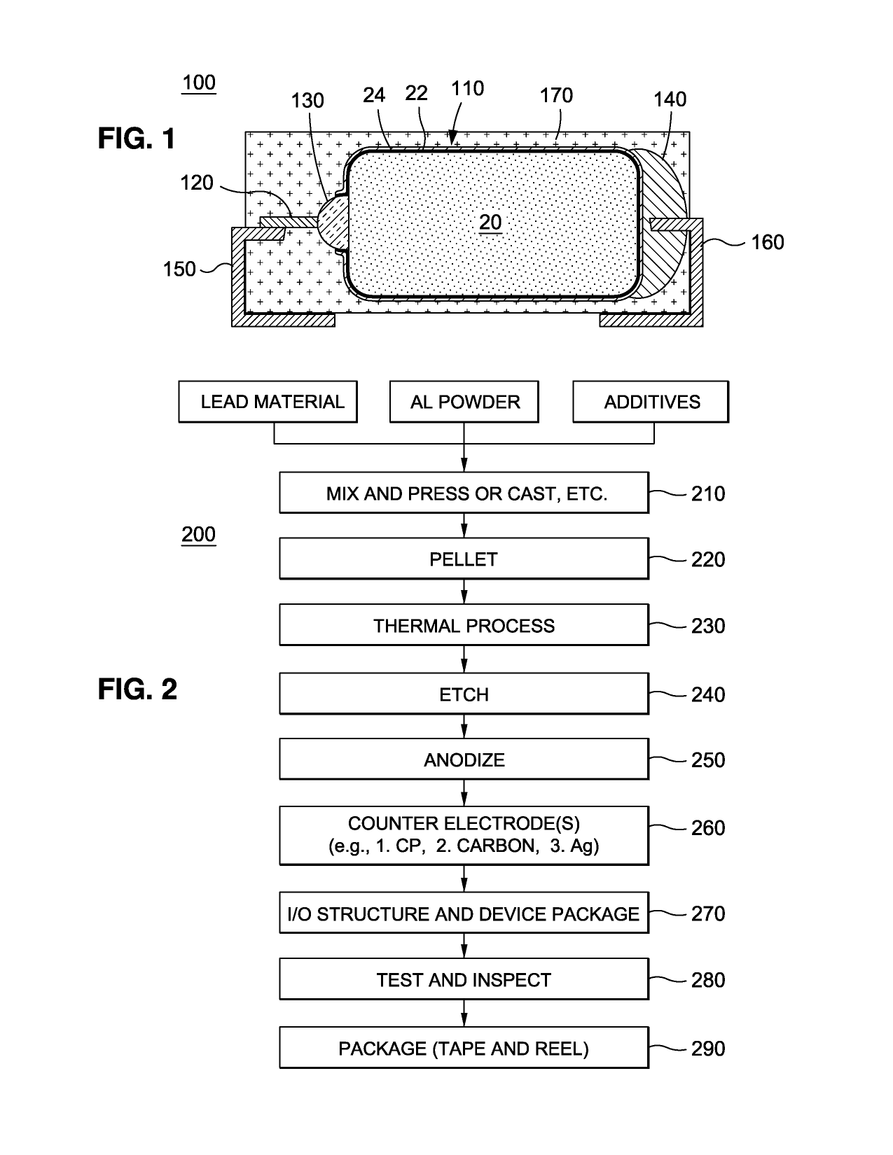

FIG. 1 shows an aluminum (Al) electrolytic capacitor 100 configured as a surface mount device according to an embodiment of the present disclosure. Unlike conventional Al electrolytic capacitors having a stacked, etched foil leaf structure, the capacitor 100 may use a pellet 110 of consolidated Al powder, which may have a significantly greater active portion due to its larger accessible open pore structure (i.e., the surface area, per unit bulk anode volume, that is accessible within and upon the anode element for formation of dielectric and counter electrode). For example, by using such a pellet 110 having an accessible open pore structure of ≥1.5 m²/cm³, the capacitor 100 may have an active portion that is increased by _{≳}80% in comparison with conventional Al electrolytic capacitors, resulting in greater C/Vol. At the same time, the conventional shortcomings of pressed pellet capacitors may be overcome by the use and processing of Al in place of tantalum or niobium, as the Al pellet can be etched to greatly increase the accessible open pore structure, unlike the tantalum or niobium pressed pellets which are not etched after pressing. The ability to etch the Al pellet may also advantageously allow the accessible open pore structure and thus C/Vol. to be easily adjusted by increasing or decreasing the amount of etching as desired for a particular application.

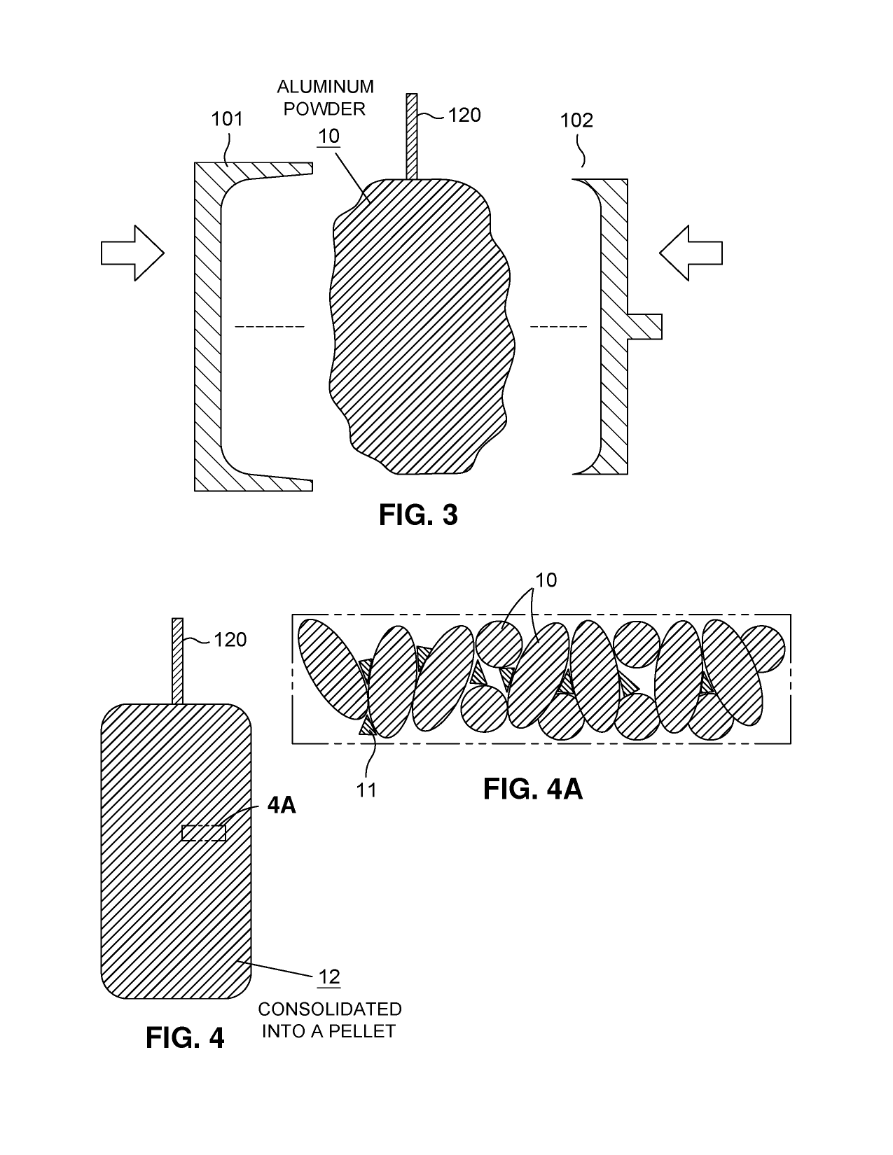

Referring to the example process flow shown in FIG. 2, a method of manufacturing an aluminum electrolytic capacitor such as the surface mount capacitor 100 shown in FIG. 1 may begin as shown in FIGS. 3 and 4 with consolidating aluminum powder 10 into a porous pellet 12. The consolidated Al powder 10 may comprise one or more of spherical, spheroidal, granular, nodular, irregular, flake, acicular, or fibrillar shaped powder(s) or the like. The major diameter size of the Al powder 10 is not limited and may range from submicron to ≥5 mm. The Al powder 10 may be consolidated via one or more of rolling, pressing, casting, extrusion, thick film deposition, or the like (Step 210). For example, the Al powder 10 may be placed in a cavity of a die 101 and compressed by a press 102 as illustrated in FIG. 3. The resulting porous pellet 12 (Step 220) may be characterized by significant accessible open pore surface area. Typically, this consolidation results in a porous pellet 12 exhibiting packing factor (PF) that is ≥15% and ≤93%. The PF may preferably range between 25% and 80% and most preferably between 35% and 60%. Preferably, the Al powder 10 used is highly pure (e.g., ≥99% pure, more preferably ≥99.6 % pure). It is also preferable that the crystal structure of the Al powder 10 be highly cubic, in some cases undergoing processing to achieve a highly cubic crystal structure.

As represented in FIG. 2, the Al powder 10 may be combined with various additives. For example, the Al powder 10 may be treated with surface additives to inhibit or prevent oxidation during handling or to achieve other properties as desired. Prior to consolidation, the Al powder may be premixed with binder material, such as poly(alkylene carbonate), steric acid, oleic acid, or the like, so as to aid in imparting mechanical strength to the “green” (i.e., not yet thermally processed) pellet. Other additions may be made to achieve desired “green” pellet properties as well. Said additions may be made dry or in suspension, with care being taken to avoid oxidation or other undesirable reactions of the Al power 10. The closeup view of FIG. 4A illustrates such binders, organics, and other additives 11 mixed with the Al powder 10, with the empty areas in between representing pore channels.

As further represented in FIG. 2, a lead material 120 such as lead wire, lead strip, foil backing or the like, which is comprised of preferably Al, or other compatible electrically conductive material(s), may be combined with the Al powder during the pelleting operation so as to enable the pellet 12 to have desired electrical, thermal, and/or mechanical connection to the outside environment in subsequent operations and/or in use. In this regard, as depicted in FIGS. 3 and 4, the process may include inserting a conductive lead 120 into the porous pellet 12. The conductive lead 120 may be inserted prior to anodization in order to prevent shorting between the anode (via the conductive lead 120) and the cathode to be formed on the anodization layer as described below. Preferably, the conductive lead 120 may be inserted prior to sintering as described below (e.g., before, during, or after consolidation of the Al powder 10 into the pellet 12) Alternatively, lead 120 may be attached via welding or the like after thermal processing (230) and before anodization (250).

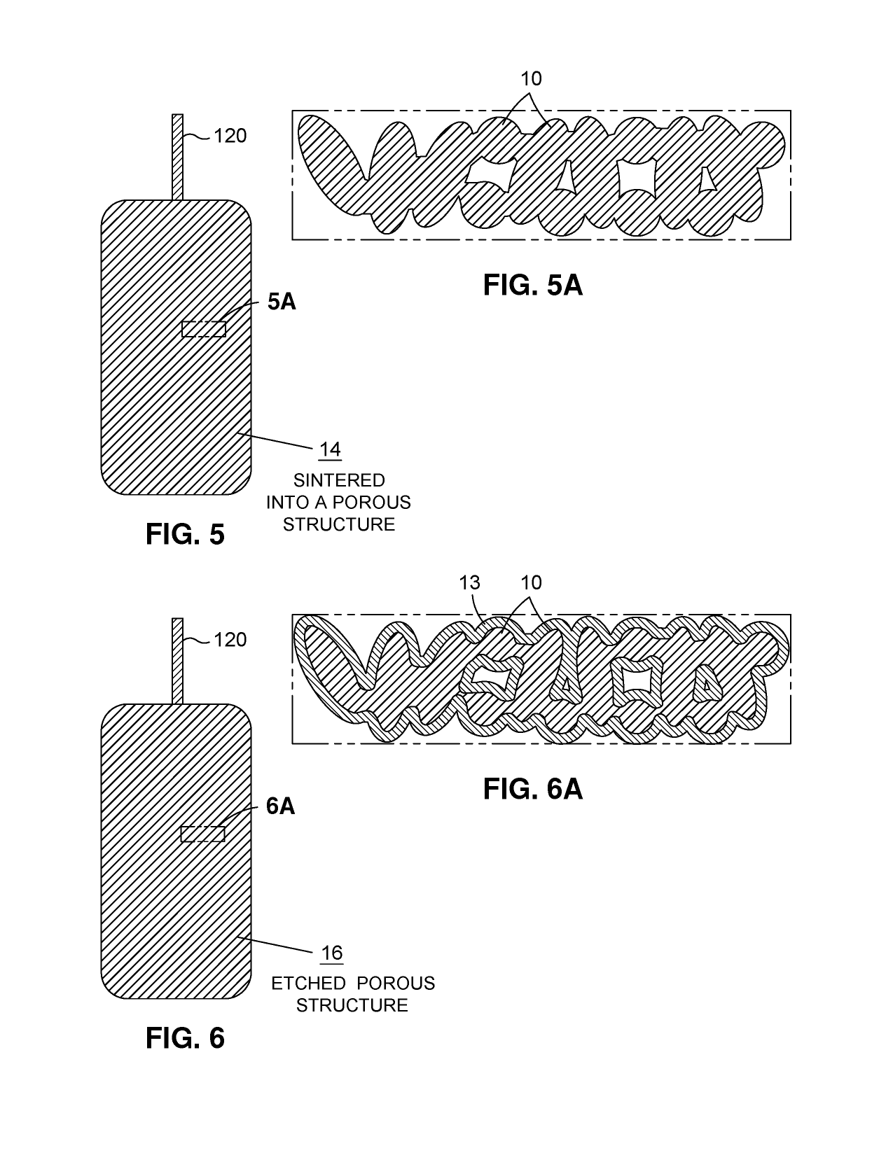

The resulting porous pellet 12 may then be thermal processed, which may remove organic additives and develop mechanical joins between particles so as to develop mechanical strength without appreciably reducing open pore volume (Step 230). Thus, mechanical integrity of the pellet 12 may be established while preserving a suitable portion of the accessible open pore surface area. The resulting porous structure 14 is shown in FIG. 5, with the closeup view of FIG. 5A illustrating that the binder and other additives 11 are now removed and the Al particles 10 have bonded together at touch points/areas. Thermal processing may be performed in one or more sub-steps characterized by different temperatures, durations, and/or atmospheres, such as an organic material removal step followed by a sintering step. For example, the sintering atmosphere may be selected to minimize or prevent oxidation of the Al at sintering temperature. An inert or reducing sintering atmosphere may be used. Neutral atmospheres, such as nitrogen (N₂), argon (Ar), or other inert or noble gas, may be used. Preferably, a reducing atmosphere is utilized. Use of a reducing atmosphere may advantageously help to control oxidation of the Al. Examples of reducing atmospheres may include atmospheres based upon hydrogen, either pure or mixed with inert or noble gas, or wet hydrogen (i.e., hydrogen mixed with water vapor) alone or mixed with an inert gas, or gaseous ammonia, or CO/CO₂, or combinations thereof, or the like. A maximum thermal processing temperature may be selected to achieve a desired degree of sintering without excessive densification so as to preserve accessible open pore surface area. The temperature may range from 280 ºC to 655 ºC, preferably from 300 ºC to 650 ºC and most preferably from 315 ºC to 635 ºC. Sintering time may be selected to achieve target pore structure combined with suitable mechanical properties of the resulting porous Al pellet 14. After thermal processing, the consolidated porous pellet 14 may be treated to remove any existing oxidation, impurities or the like. The pellets may then be racked by mechanically/electrically connecting them to a lead super structure (rack), e.g., by the lead 120. Connection of the pellet to the rack may be achieved via mechanical clamping, or by welding or by attachment using a conductive adhesive or the like.

The sintered porous pellet 14 may then be etched to increase accessible open pore surface area (Step 240), resulting in an etched porous structure 16 having a high surface area region 13 as represented in FIGS. 6 and 6A while maintaining mechanical integrity and electrical interconnection. Etching may be chemical or electrochemical or a combination thereof, with electrochemical etching being preferable. The form of current used during electrochemical etching may be direct current, alternating current, pulsed current, or a combination thereof. Preferably, an alternating current is used. The electrochemical etching bath may comprise an acid, preferably a weak acid. Alternatively, the electrochemical etching bath may be a basic chemistry. Preferably, the electrochemical etching bath may include one or more organic acid(s), in combination with one or more mineral acid(s), and may contain chloride ions such as from hydrochloric acid, or from ferric chloride or the like. The electrochemical etching process may be carefully selected to increase accessible open pore surface area without degrading the mechanical properties of the sintered, porous powder pellet 14.

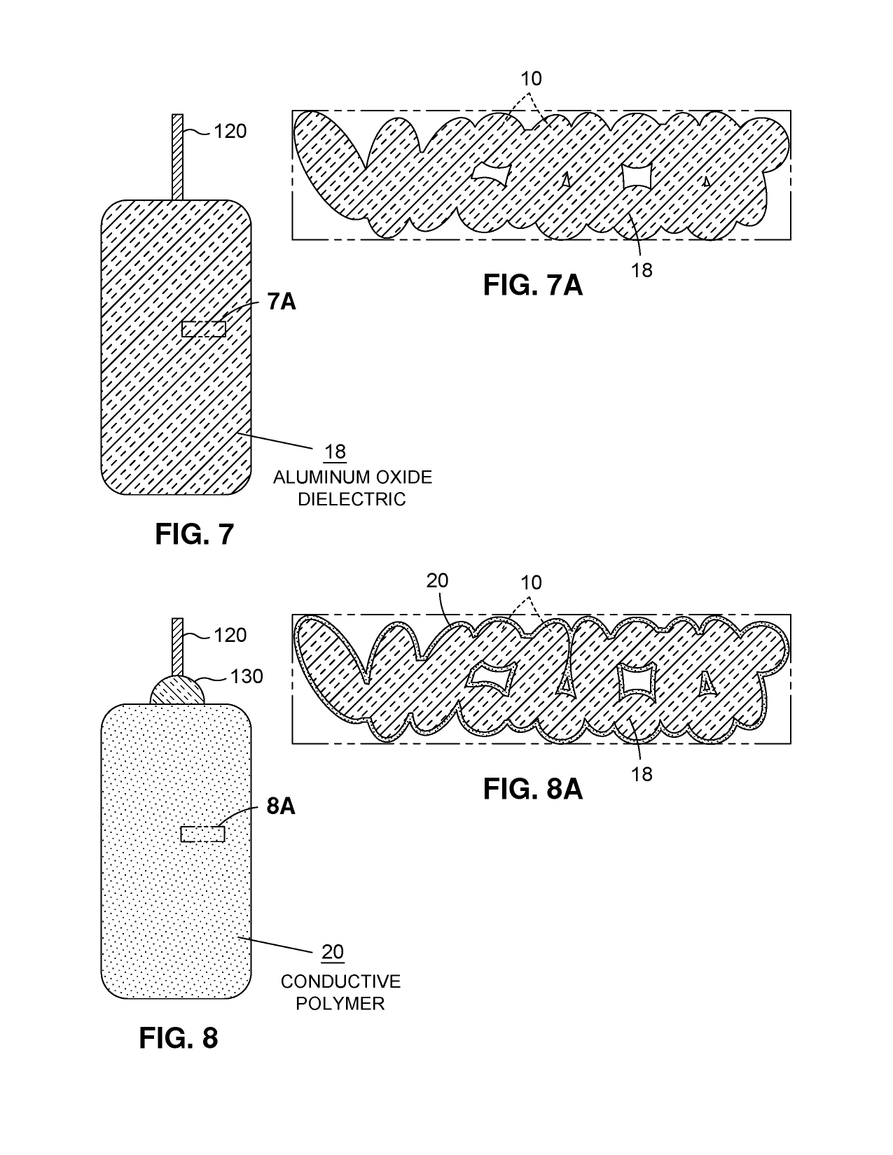

The etched Al powder pellet 16 may then be anodized to establish the dielectric portion of the Al electrolytic capacitor 100 as represented in FIGS. 7 and 7A (Step 250). For example, the pellet 16 may be cleaned in a suitable bath to remove any smut, debris or the like, and may then be anodized to form a dielectric layer 18, preferably an oxide of aluminum such as Al₂O₃. Formation of the oxide may be performed in an anodizing chemistry that is selected to form an oxide film without simultaneous dissolution of said film. The anodizing chemistry may include one or more weak acids or salts thereof, alone or in combination. Anodizing acids may be boric acid, borax and associated salts, ammonium boric acid and associated salts, one or more amine phosphates such as ammonium phosphate, di-ammonium phosphate and associated salts, adipic acid and associated salts, such as ammonium adipate, ammonium adipic acid and associated salts, dimethyl ethoxy ethanolamine, dimethyl ethanolamine, and associated salts, tartaric acid and associated salts, citric acid and associated salts, ammonium citrate, tri-ammonium citrate and associated salts, phosphoric acid and associated salts, other organic acids and associated salts. The bath chemistry and temperature may be selected to provide suitable bath conductivity. The voltage and current density may be selected to provide a high-quality dielectric film 18. The form of current may be direct, alternating, pulsed or a combination thereof. Generally, the formation voltage may be selected to be greater than the device rated voltage (V_{rated}) to ensure that the device will perform at V_{rated} over its intended lifetime. The voltage may be ramped gradually to the full formation voltage in order to prevent burning of the anodized film 18 or the like. The anodizing process may preferably be performed for a duration such that leakage current of the anode is minimized to well below the allowable device leakage current, ensuring the desired performance of the capacitor device 100. After anodizing, the formed anodes may be rinsed, then dried. The drying temperature and duration may be selected to preserve or restore (e.g., dehydrate) the preferred Al₂O₃ dielectric, which may become hydrated prior to said drying. This may be achieved by drying the formed anodes at temperature above 150 ºC (and ≤400 ºC) for 30 minutes or longer.

The anode and dielectric portion of the capacitor 100 may then be further processed to achieve the final capacitor structure via establishment of the cathode (Step 260), as well as any lead out structure(s), and/or packaged structure as desired/required for the target application (Step 270). For example, the counter electrode or cathode may be impregnated into the accessible open pore structure to cover the accessible open pore surface area. This may be done carefully to establish full coverage of the cathode while avoiding damage of the dielectric film. The counter electrode may comprise multiple chemistries and/or layers of chemistries. For example, a conductive polymer (CP), or precursor thereof, may be infiltrated into the open pore structure of the formed anode by dipping into a CP or CP precursor liquid of relatively low viscosity and appropriate wetting properties. The dipping rate and immersion time may be selected to ensure complete coverage of the accessible open pore surface area. In order to maximize coverage of the cathode material, ultrasonic agitation and/or pressure and/or vacuum may be used as part of the impregnation process. The anodes may then be removed from the solution and dried, or otherwise treated so as to develop the CP. This sequence may be repeated in order to achieve complete CP coverage of the accessible open pore surface area as represented in FIGS. 8 and 8A. The cathode or counter electrode material may comprise an organic conductor. Preferably, it may comprise one or more organic conductors such as tetracyanoquinodimethane (TCNQ), polypyrroles, polyanilines, polyacetylenes, polyindoles, poly(p-phenylene vinylene), poly(thiophene)s, poly(3,4-ethylenedioxythiophene) (PEDOT), and/or polystyrene sulfonate (PSS). Preferably, the CP counter electrode may be a combination of PEDOT and PSS which may be modified to optimize desirable capacitor properties, such as equivalent series resistance (ESR) and the like.

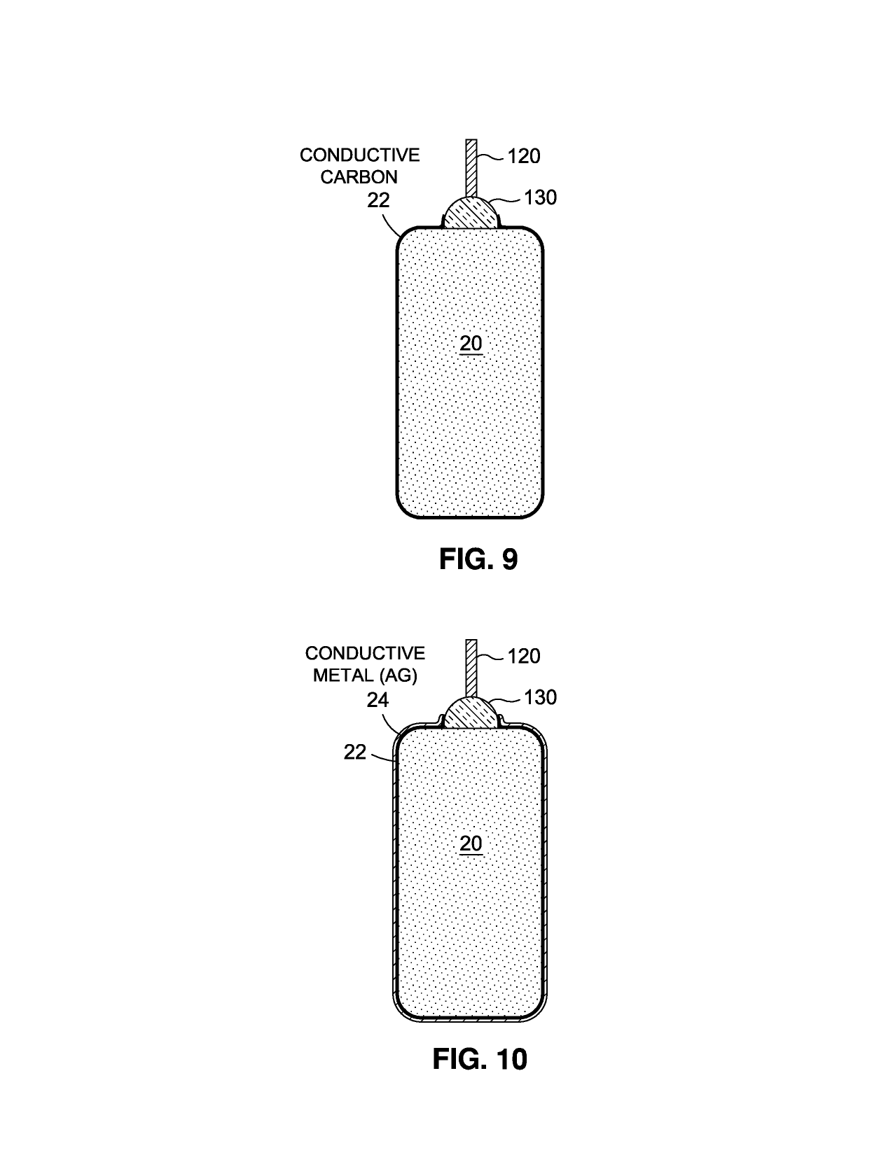

Further, the counter electrode or cathode may comprise additional layers, such as carbon black, graphite, graphene or the like next to the (CP) described above, which may be covered by a thick film metallic conductor comprising silver (Ag) thick film or sputtered thin film metal or the like. This may be done in order to present a robust conductor platform to the cathode lead frame structure, and thus a robust cathode connection to the outside world. As represented in FIGS. 9 and 10, for example, a layer of conductive carbon 22 may be provided on the outside of the conductive polymer 20, and a layer of conductive metal 24 such as silver may be provided on the conductive carbonaceous layer 22. An insulating layer 130 (e.g., an epoxy) may be provided in the region where the conductive lead 120 emerges from the pellet 12 as shown in FIGS. 8-10. The insulating layer 130 may further help to prevent shorting of the anode and the cathode as described in more detail below. During the buildup of the cathode layers, including the conductive polymer 20, conductive carbonaceous layer 22, and metallization layer 24, it is noted that the insulating layer 130 may be used to assist in the prevention of electrical interconnection between the cathode and the anode, which would result in a shorted device. For example, as represented in FIGS. 9 and 10, the conductive carbon 22 and metal 24 (as well as the underlying conductive polymer 20) may be applied so as not to extend past the insulating layer 130, thus avoiding contact with the conductive lead 120 that is electrically connected to the underlying anode.

Referring back to FIG. 1, the capacitor devices 100 including the pellet 110 (with fully formed anode and cathode) may then be packaged as desired/required (Step 270). Typically, they may be covered with an insulating encapsulation material 170 such as an epoxy coating or epoxy case or the like. An example of a packaged surface mount capacitor device 100 is shown in FIG. 1. The conductive lead 120, which was previously attached to a rack from which the pellet 110 was suspended while undergoing processing steps such as those represented in FIGS. 3-10, is now connected to an anode terminal 150 on the outside of the package, and similarly the cathode is connected to a cathode terminal 160 on the outside of the package via the metallization layer 24 and conductive carbonaceous layer 22. Connection of the metallization layer 24 to the cathode terminal 160 may be made through a conductive layer 140 (e.g., electrically conductive epoxy, such as silver thick film, or other conductive adhesive or conductive potting compound or the like) which may be disposed on the pellet 110 anywhere that is insulated from the conductive lead 120 (such as on an opposite side as shown). The conductive layer 140 and connection to terminals 150, 160 may be provided prior to the encapsulation material 170, with the terminals 150, 160 then being deformed to serve as contacts on the outside of the packaged device 100. The packaged capacitor devices 100 may then be cut from or otherwise removed from the lead superstructure to become single devices, which may then be tested/inspected and optionally marked (Step 280) and packaged into tape and reel, tray, or other types of packaging (Step 290), which may be selected for use with automated assembly equipment for mass production for example.

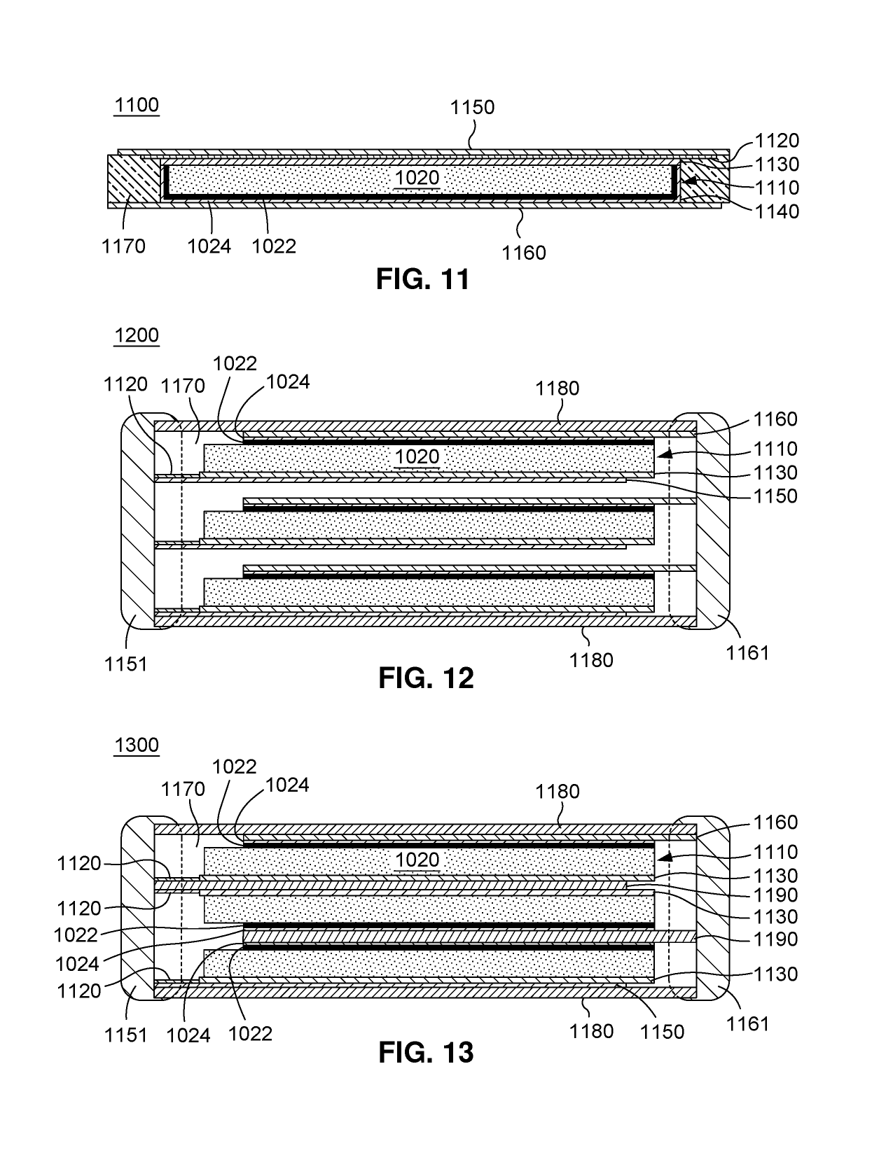

In addition to being packaged as surface mount devices 100, the contemplated capacitors described herein may be used unpackaged as embedded devices in circuit boards or as interposers between circuit board and integrated circuit (IC) or microprocessor (μP) package, or as part of the semiconductor device package or the like. By way of example, FIG. 11 shows a capacitor configured as an embedded device 1100. Like the surface mount device 100, the embeddable capacitor device 1100 may include a pellet 1110 comprising an internal anode made of consolidated aluminum powder that may be etched as described above and anodized, with a conductive polymer 1020 formed thereon conformally with the anodized porous structure. Cathode buildup layers such as a conductive carbonaceous layer 1022 and a metallization layer 1024 may be provided thereon, which is electrically insulated from a conductive foil backing 1120 or other (anode) lead that is connected to the internal aluminum anode. An insulating layer 1130 may be optionally provided to prevent shorting between the cathode layers 1020, 1022, 1024 and the conductive foil backing 1120. The conductive foil backing 1120 of the anode may be connected to a power rail 1150. The metallization layer 1024 of the cathode may be electrically connected to ground plane 1160. Each of 1150 and 1160 may be part of package substrate, interposer, printed circuit board (PCB), or other substrate, for example. Electrically insulating material 1170 of the substrate may electrically isolate capacitor 1100 from other circuit elements as desired.

The embeddable pellet 1110 may be used in myriad configurations/embodiments, such as (but not limited to) the demonstrative examples herein. Individual devices such as the capacitor device 1100 of FIG. 11 may be stacked or placed side by side to achieve a plethora of configurations/embodiments. Additionally, the stacking configuration may be inverted (e.g., cathodes or anodes stacked face-to-face), or the like so as to improve volumetric efficiency or other desired parameter(s). Further, multiple device stacks or other configurations of multiple devices, may be electrically connected in series, parallel or hybrid configurations as required to suit the application. These connections may be made by way of one or more end terminations, internal conductive vias or other electrical connection means. Further, the devices may be embedded in a circuit board, either in stacked arrangement or singularly, side-to-side, or other configurations as prudent. The flexibility of application leads to myriad potential embodiments of the disclosed subject matter as would be understood by one skilled in the art. It is noted that the orientations and stacking arrangements in the illustrated embodiments may be flipped, with references to “top” and “topmost” being replaced with “bottom” and “bottommost” and vice versa.

FIGS. 12-15 show example capacitors configured as multilayer devices 1200, 1300, 1400, and 1500, respectively. In FIG. 12, three embeddable pellets 1110 are shown in a stacked configuration in which anode sides of each pellet 1110 all face the same direction (downward in the illustrated orientation). Cathode buildup layers (e.g., conductive carbonaceous layer 1022 and metallization layer 1024) may be electrically connected to respective conductive layers 1160 of the device 1200, which may be connected to a cathode terminal 1161 on one side of the device 1200. Conductive foil backings 1120 or other anode leads may be connected to respective conductive layers 1150, which may be connected to an anode terminal 1151 on another side of the device 1200 (e.g., opposite the cathode terminal 1161 as shown). An insulating layer 1130 may be provided to prevent a short between the conductive foil backing 1120 and the cathode layers 1020, 1022, 1024. The anode and cathode terminals 1151, 1161 may be insulated from each other by dielectric insulating coatings 1180 (shown on top and bottom of the multilayer device 1200) as well as by the insulating material 1170 of the package substrate, interposer, PCB, or other substrate of the multilayer device 1200.

FIG. 13 shows another example multilayer device 1300, this time with the three embeddable pellets 1110 stacked so that the anode sides of the two upper pellets 1110 face each other and the cathode sides of the two lower pellets 1110 face each other so as to increase packaging efficiency or the like. Here, an electrically conductive adhesive 1190 may be provided between adjacent pairs of cathodes and between adjacent pairs of anodes. More specifically, the cathode buildup layers (e.g., conductive carbonaceous layer 1022 and metallization layer 1024) of one pellet 1110 may be connected to the cathode buildup layers of an adjacent pellet 1110 via an electrically conductive adhesive 1190 that is connected to a cathode terminal 1161 on one side of the device. In the case of a topmost pellet 1110 that does not have another adjacent pellet 1110, the cathode buildup layers may instead be electrically connected to a conductive layer 1160 on top of the device 1300 as shown, which may in turn be connected to the cathode terminal 1161. Likewise, the conductive foil backing 1120 or other anode lead of one pellet 1110 may be connected to the conductive foil backing 1120 or other anode lead of an adjacent pellet 1110 via another electrically conductive adhesive 1190, and one or more of these may be is connected to an anode terminal 1151 on one side of the device (e.g., opposite the cathode terminal 1161). In the case of a bottommost pellet 1110 that does not have another adjacent pellet 1110, the conductive foil backing 1120 or other anode lead may instead be electrically connected to a conductive layer 1150 on a bottom of the device 1300 as shown (which may in turn be connected to the anode terminal 1151).

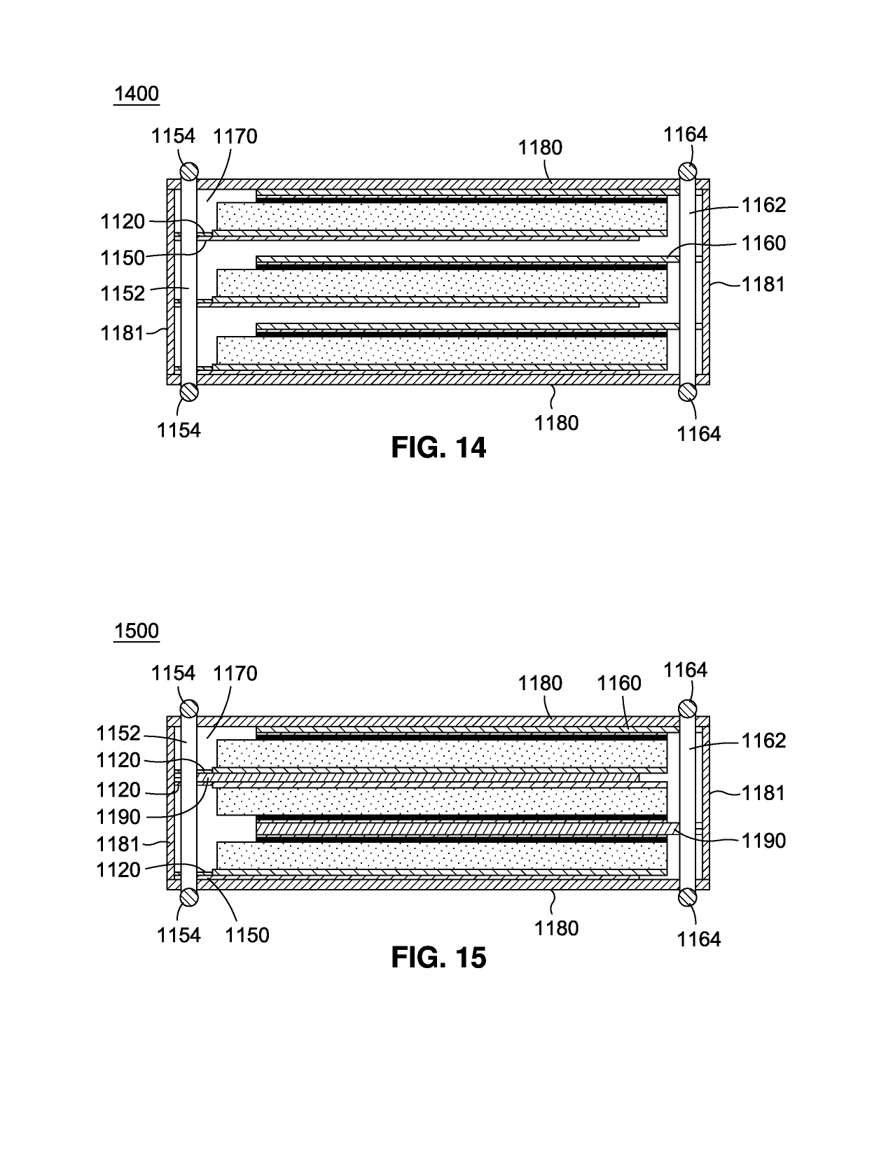

FIGS. 14 and 15 show additional example multilayer devices 1400 and 1500, which are variants on the multilayer devices 1200 and 1300, respectively. In place of anode and cathode terminals 1151, 1161 on the sides of the devices 1200, 1300, the devices 1400 and 1500 may instead have anode terminal(s) 1154 and cathode terminal(s) 1164 on the top and/or bottom of the device 1400, 1500. To this end, anode vias 1152 may be formed (e.g., drilled and filled with a conductive via fill) extending through the insulating material 1170 and the foil/lead 1120, conductive layer 1150, and/or conductive adhesive 1190 on one side of the device 1400, 1500 (left side in the figures, electrically connected to the anodes within the pellets 1100 as described above). The anode vias 1152 may terminate on top and/or bottom of the device with one or more conductive pads, balls, or other terminals 1154. Likewise, cathode vias 1162 may be formed (e.g., drilled and filled with a conductive via fill) extending through the insulating material 1170 and the conductive layer 1160, and/or conductive adhesive 1190 on the other side of the device 1400, 1500 (right side in the figures, electrically connected to the cathodes within the pellets 1100 as described above). The cathode vias 1162 may terminate on top and/or bottom of the device with one or more conductive pads, balls, or other terminals 1164. The terminals 1154, 1164 may be used to surface mount the device 1400, 1500, for example. Dielectric insulating coatings 1181 may be provided on the sides of the device 1400, 1500 to insulate the device from laterally adjacent devices.

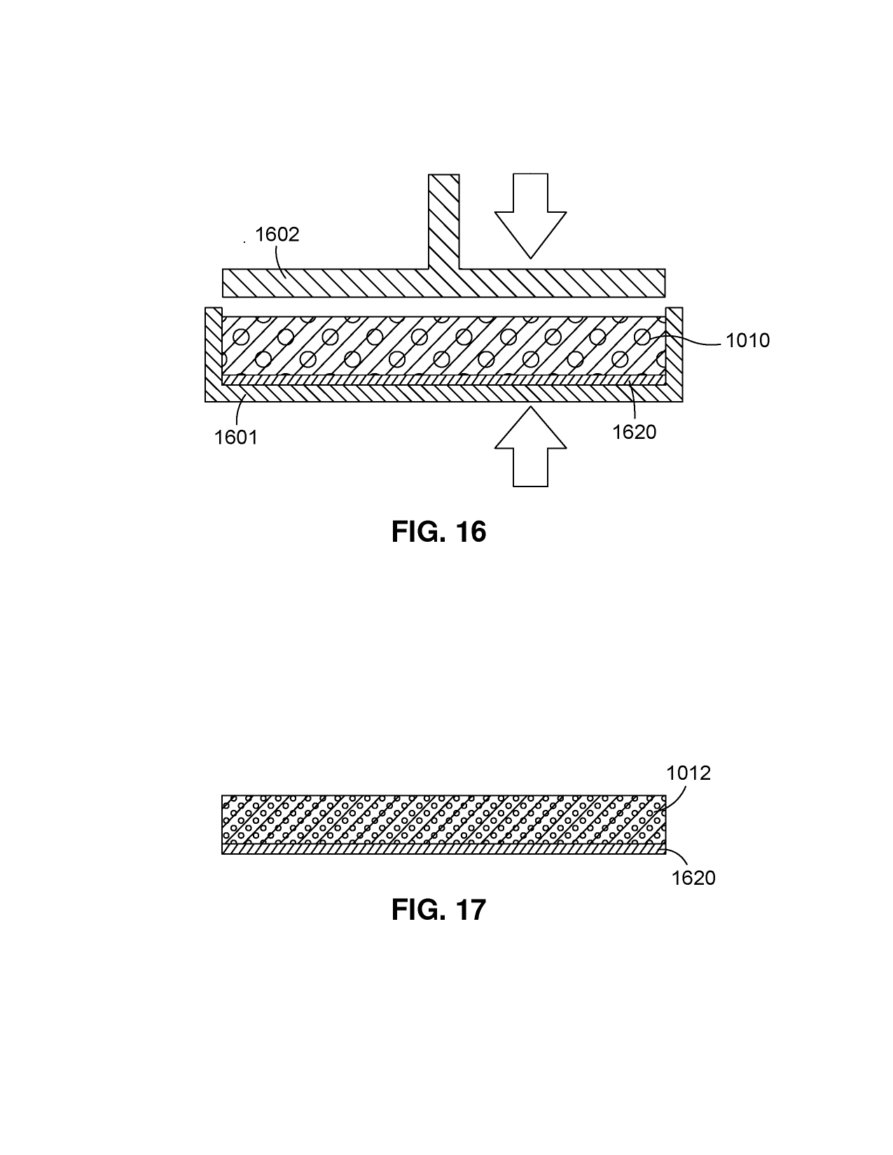

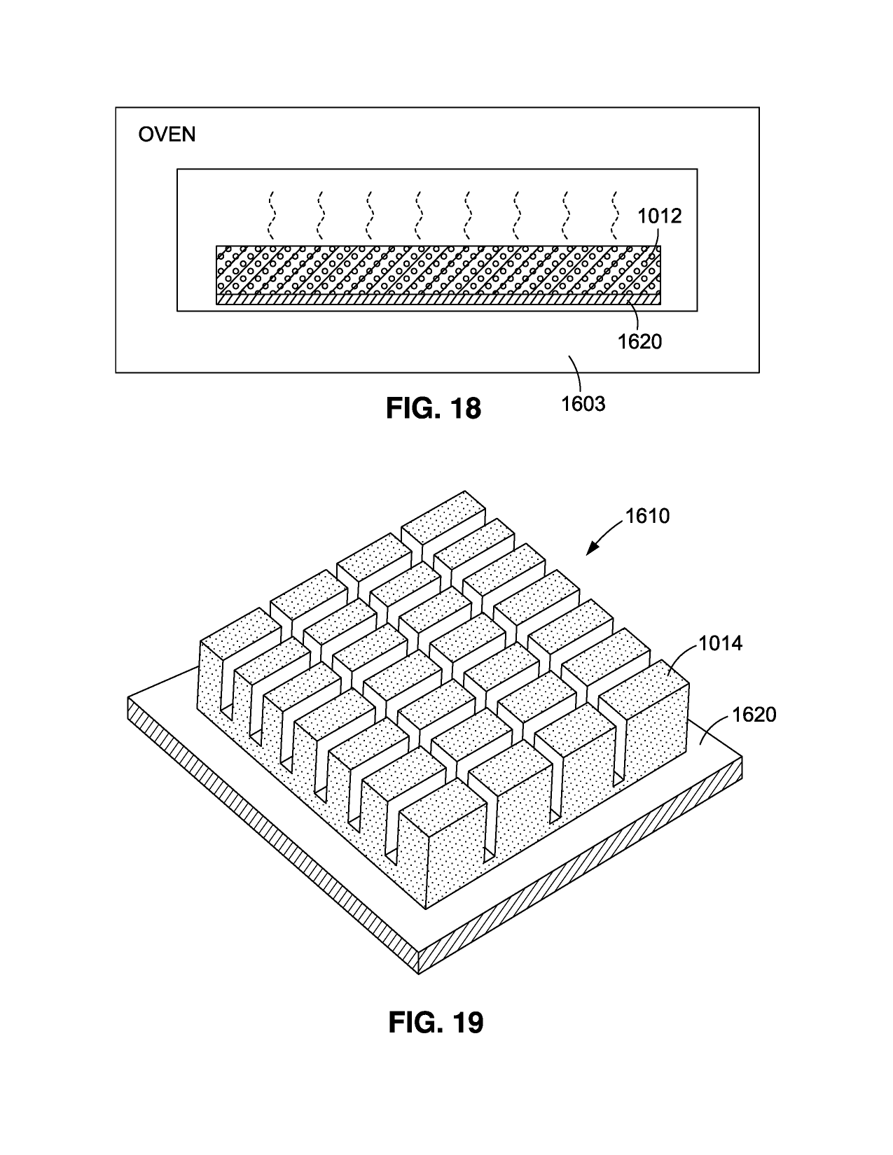

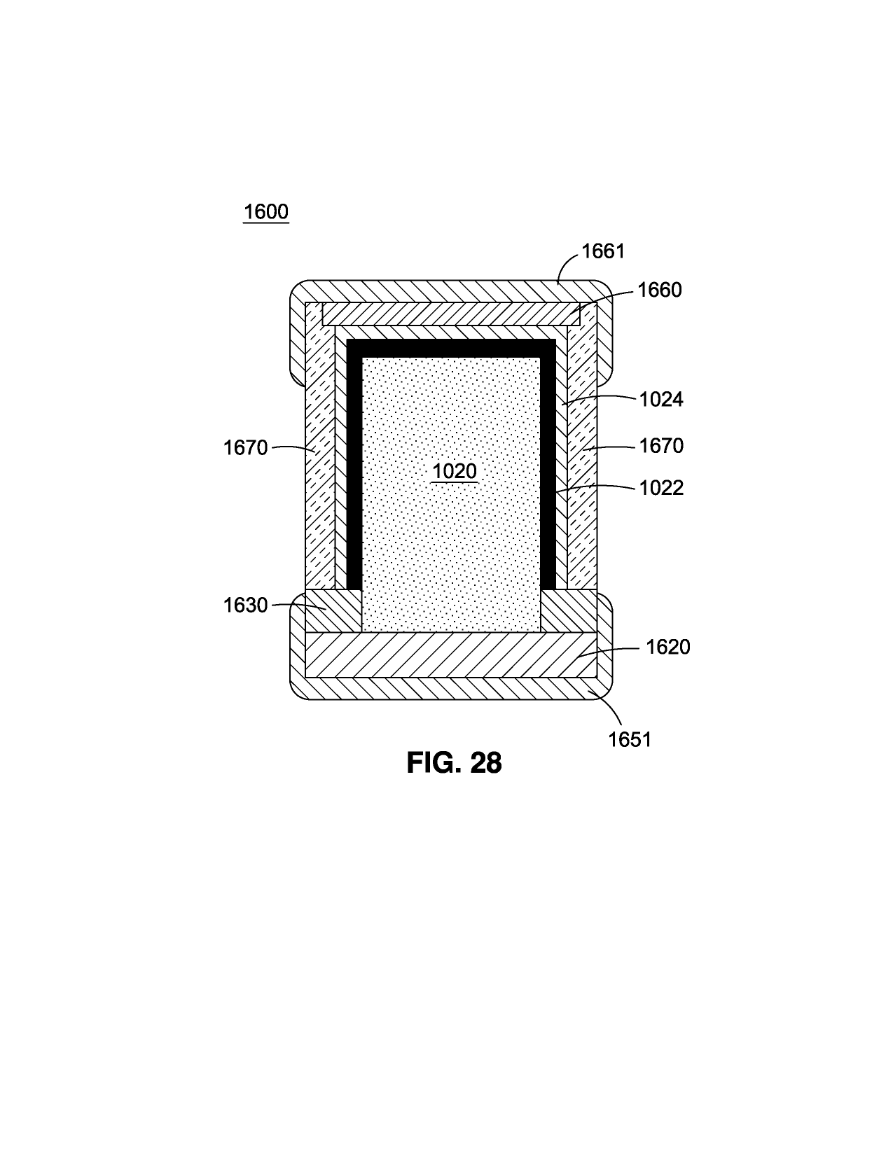

FIGS. 16-27 show stages of an example process for manufacturing an array 1610 of capacitors (see FIG. 19), with FIG. 28 showing a singulated capacitor device 1600 from the array 1610. The process may begin with batching and mixing together aluminum powder 1010 including aluminum flakes and/or spheres, etc. (along with any additives as described above) and pressing the mixture together with a metallic or otherwise conductive supporting foil 1620 or other lead structure (Step 210 of FIG. 2). For example, as shown in FIG. 16, the mixture may be placed in a cavity of a die 1601 along with the supporting foil 1620 and compressed by a press 1602 to a desired shape of a pressed ingot 1012 as shown in FIG. 17 (Step 220 of FIG. 2) as detailed above. The ingot 1012 with foil 1620 may then be placed in an oven 1603 as shown in FIG. 18 for thermal processing to remove any organics and to partially sinter the particles together as well as to the foil 1620, typically in a reducing atmosphere (Step 230 of FIG. 2) as detailed above. As shown in FIG. 19, the resulting thermally processed ingot 1012 may be cut to create an array 1610 of consolidated pellets 1014 (e.g., sliced horizontally and vertically to make a grid), for example, by dado cuts stopping at or above the foil 1620.

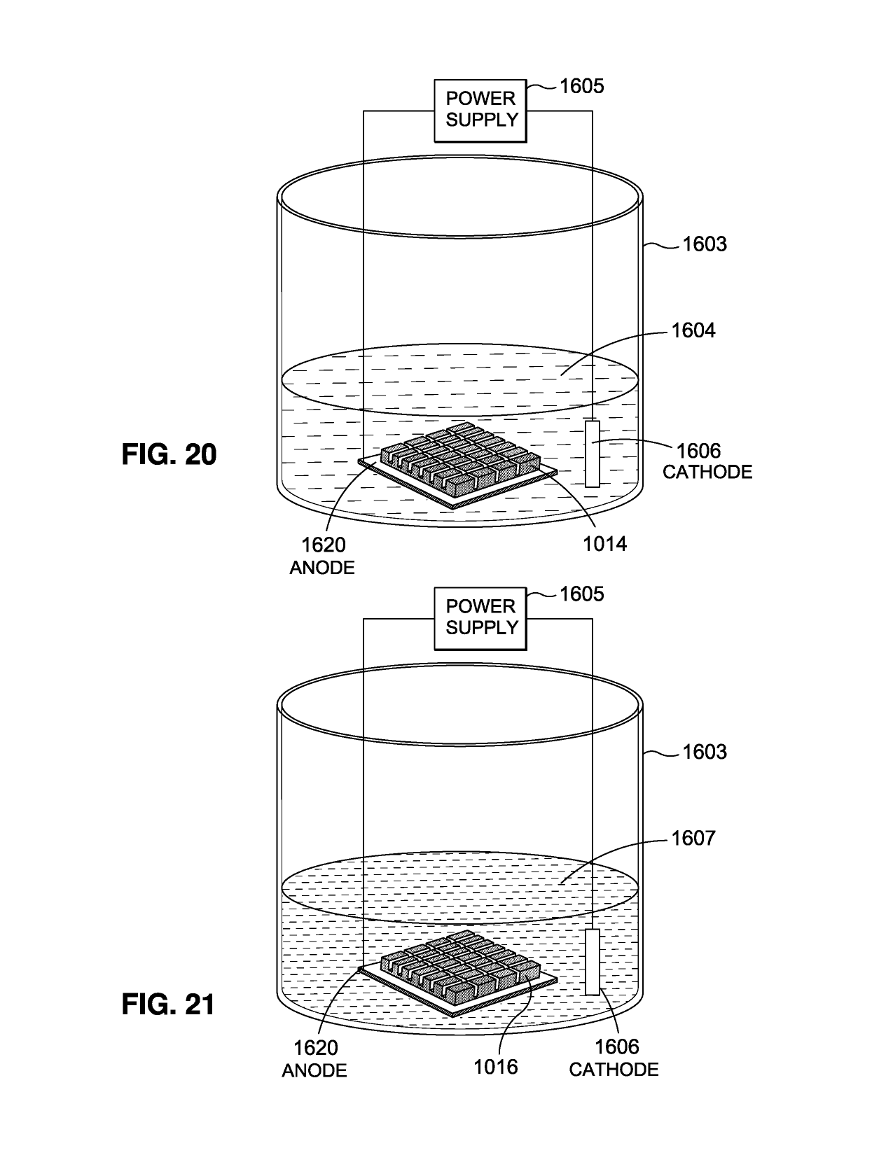

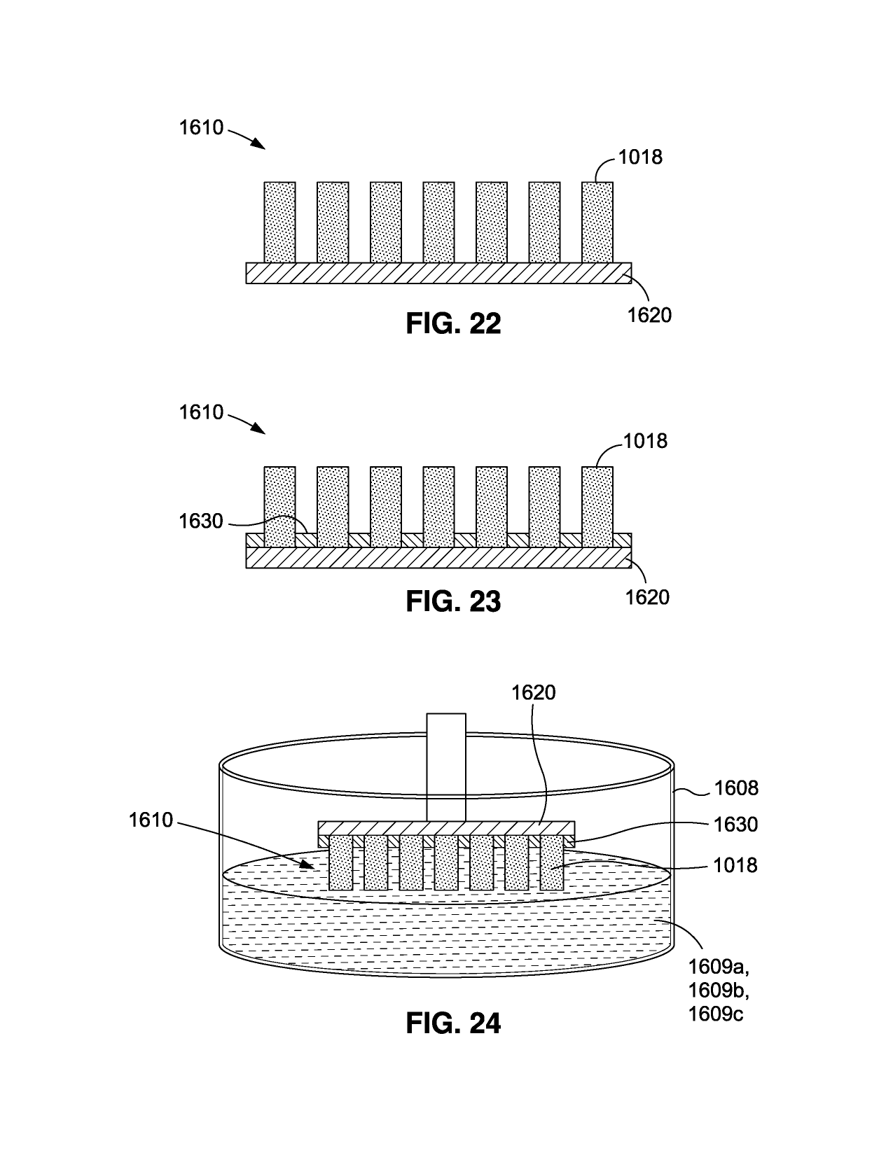

The array 1610 of consolidated pellets 1014 with backing foil 1620 may subsequently undergo etching (e.g., chemical, electrochemical, or a combination) as described above to maximize the accessible open pore area of each consolidated pellet 1014 (Step 240 of FIG. 2). For example, as shown in FIG. 20, the array 1610 may be placed in a container 1603 containing an electrochemical etch bath 1604, and the terminals of a power supply 1605 may be electrically connected to the foil 1620 (anode) with a piece of metal or other cathode 1606 submerged in the etch bath 1604, and the anode configuration may be etched/electrochemically etched as detailed above until the desired degree of etching has occurred. FIG. 21 illustrates a similar setup, this time with the container 1603 (or a different container) being filled with an anodizing bath 1607 having an anodizing chemistry as described above. In this way, the etched pellets 1016 may be anodized as described above (Step 250 of FIG. 2), resulting in the formation of an oxide dielectric layer 1018 conformally disposed on the etched porous surface of the aluminum as shown in FIG. 22. The oxide may be selectively removed from the back of the foil 1620 if necessary, for example, by NaOH, and/or by abrasion, or the like. As shown in FIG. 23, an insulating layer 1630 may be installed by injection and then cured into the bottom of the channel of FIG. 23, or a preform (typically epoxy) may be deposited there, then thermal treated to flow/cure the epoxy, or the like, or the like, filling in the channels between the individual pellets of the array 1610. The insulating layer 1630 may be functionally equivalent to the insulating layer 30 described above, for example, and may help to prevent a short between the foil 1620 (anode) and the subsequently formed cathode buildup layers.

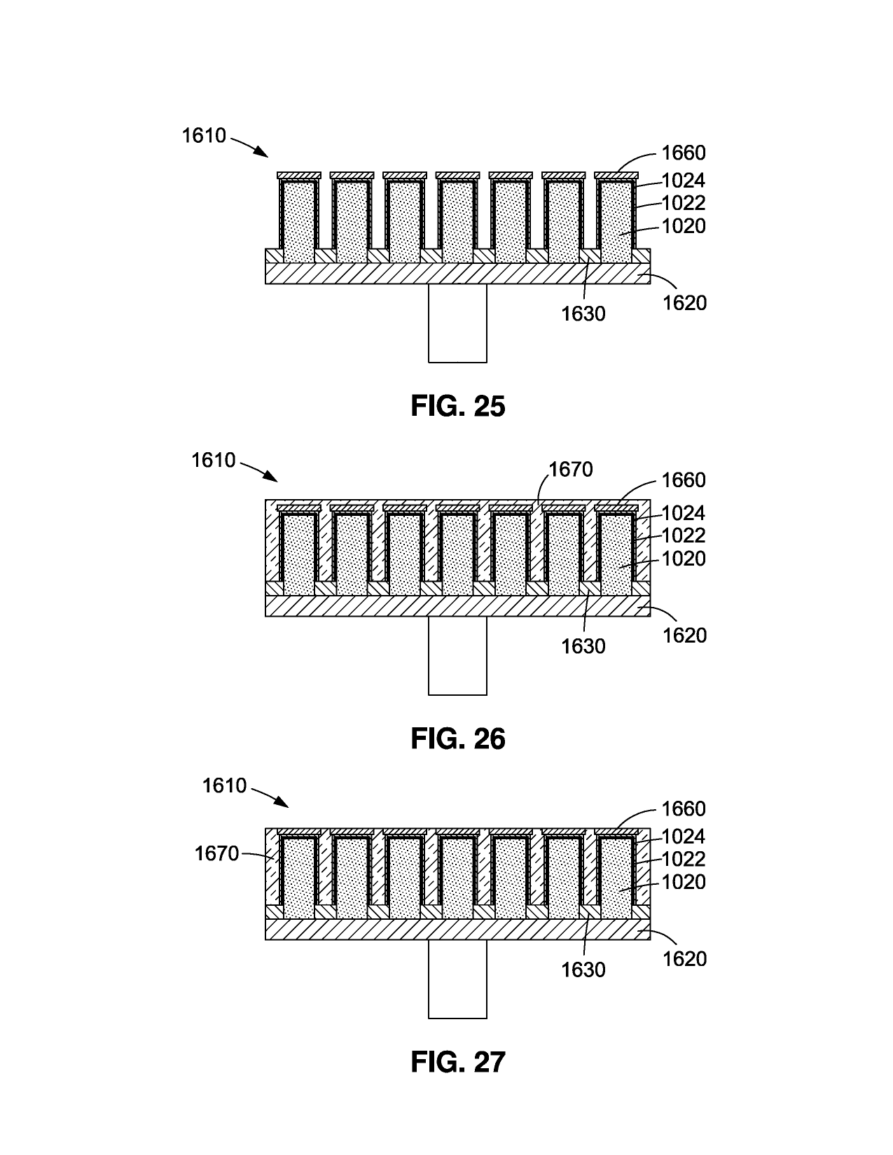

FIG. 24 illustrates the array 1610 of pellets inverted and undergoing precision dipping in a container 1608 (or multiple containers) to form the cathode buildup layers (Step 260 of FIG. 2), with a conductive polymer layer first being formed conformally on the oxide dielectric layer 1018 within the high surface area open pore structure of the pellet by dipping in a conductive polymer bath 1609a. Thereafter, the array 1610 of pellets may be dipped in a carbon bath 1609b to form a conductive carbonaceous layer, followed by a silver or other metal bath 1609c to form a metallization layer. The dipping processes may be the same as those described above in relation to FIGS. 8,9 and 10 respectively. Drying and/or curing may be performed between each dipping process. The resulting array 1610 of pellets, reinverted, can be seen in FIG. 25, including the conformal conductive polymer 1020 as well as the conductive carbonaceous layer 1022 and the metallization layer 1024 (which may be the same as layers 20, 22, and 24 described above). As can be seen, the insulating layer 1630 provided in the channels of the array of pellets may help to prevent the cathode buildup layers from contacting the foil 1620 (which could cause a short between cathode and anode). It is noted that the conductive polymer 1020 may flow into the porous structure past the insulating layer 1630 while still being electrically isolated from the underlying aluminum anode by virtue of the oxide dielectric layer 1018 (which corresponds to layer 18 described above). As shown in FIG. 25, a cathode transition conductor 1660 (e.g., a cathode plate foil) may be added at this stage in contact with the metallization layer 1024 at a location corresponding to an intended location for an external terminal of each individual capacitor device 1600, such as on top of each pellet of the array 1610 as shown.

As shown in FIG. 26, the channels between the individual pellets of the array 1610 may be filled in with an epoxy or other insulating material 1670, which may be cured as needed. A portion of the insulating material 1670 may then be removed (e.g., by abrasion, grinding, etc.) as shown in FIG. 27 to expose the cathode (e.g., the cathode transition conductor 1660). The individual capacitor devices 1600 may then be singulated from the array 1610 by cutting along the channels of the array 1610, after which they may be marked on the outside to indicate polarity. An example singulated capacitor device 1600 is shown in FIG. 28, in which an external anode terminal 1651 and an external cathode terminal 1661 have been provided on the bottom and top of the device 1600 in contact with the foil 1620 (anode) and transition conductor 1660 (cathode), respectively. The external terminals 1651, 1661 may be installed by precision dipping followed by curing as needed (Step 270 of FIG. 2) or by dry plating, or the like. The finished device 1600 may then be inspected, tested, marked and packaged (Steps 280, 290 of FIG. 2). It is noted that the same processes shown in FIGS. 16-27 may be used, with or without cutting to form an array 1610, to produce a consolidated aluminum pellet of a variety of shapes and sizes, e.g., the pellet 110 of the capacitor 100 shown in FIG. 1 or the embeddable pellets 1110 that are part of the capacitors 1100, 1200, 1300, 1400, 1500 shown in FIGS. 11-15.

As described above, the disclosed subject matter involves maximizing accessible open pore surface area of Al capacitor anodes via utilization of select consolidated Al powders combined with etching to further increase said accessible open pore surface area, in a manner that enables maximization of said surface area, and thus capacitance, beyond what is capable with the current state-of-the-art. This may be accomplished in a manner that is better for mass manufacturing, enabling higher yield and reduced cost. Using the innovative structures and methods described herein, it is proposed that C/Vol., as well as C/g may be improved significantly over the state-of-the-art. For example, it is projected that maximum capacitance in a 7343-20 (metric) case size and at 6.3 V_{rated} exceeding 220 μF may be achieved when a consolidated Al powder pellet with accessible open pore structure of 1.5 m²/cm³ or more is utilized. This may be accomplished, for example, using an Al powder having characteristic surface area ≥0.17 m²/g, consolidated to an accessible open pore surface area of 0.16 m²/cm³, then etched to achieve a gain of 10X or 1.6 m²/cm³.

Al powders applicable to the disclosed subject matter are available with surface area well-exceeding 0.17 m²/g. Further, gains of etched Al may achieve or exceed a factor of 100X. As such, it is contemplated that use of the disclosed structures and methodologies to fabricate Al electrolytic capacitors can result in C/Vol. as well as C/g exceeding the current state-of-the-art significantly. For example, successful use of an Al flake-type powder or a mixture of flake and sphere or the like, with specific surface area (SSA) of 0.75 m²/g and consolidated to a pre-etched, accessible open pore surface area of ~0.70 m²/cm³, then etched to a gain of ~10X (i.e., to an accessible open pore surface area of ~7.0 m²/cm³), yields a predicted C/Vol. exceeding 16,000 μF/cm³, enabling a capacitance exceeding 1,000 μF in the 7343-20 case size detailed above, more than 4X the current state-of-the-art value of 220 μF.

The embodiments of the disclosed device include, but are not limited to, solid conductive polymer aluminum electrolytic surface mount capacitors, package substrate embedded capacitors, and interposer capacitors. As exemplified above, the capacitors may be processed as individually racked devices, or as an array that is processed in a multi-device configuration that is later singulated into individual components. Individual devices may be stacked or placed side by side to achieve a plethora of configurations/embodiments. Additionally, the disclosed stacking configurations may be inverted (e.g., cathodes or anodes stacked face-to-face) or the like so as to improve volumetric efficiency or other desired parameters. Further, multiple device stacks or other configurations of multiple devices may be electrically connected in series, parallel or hybrid configurations as required to suit the application. These connections may be made by way of one or more end terminations, internal conductive vias, or other electrical connection means. Further, the devices may be embedded in a circuit board, either in stacked or singular, or side-to-side, or other configurations as prudent. The potential flexibility of application leads to myriad potential embodiments of the disclosed subject matter as would be understood by one skilled in the art.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of manufacturing an aluminum electrolytic capacitor for a semiconductor device, the method comprising:
consolidating aluminum powder into a porous pellet;
sintering the porous pellet;
etching the porous pellet to increase a surface area thereof;
anodizing the porous pellet to form an aluminum oxide dielectric layer on the etched porous pellet; and
providing a conductive polymer layer on the aluminum oxide dielectric layer.

2. The method of claim 1, further comprising inserting a conductive lead into the porous pellet prior to said sintering.

3. The method of claim 2, wherein said inserting the conductive lead is performed prior to said consolidating.

4. The method of claim 1, further comprising providing a conductive carbonaceous layer on the conductive polymer layer.

5. The method of claim 4, further comprising providing a metallization layer on the conductive carbonaceous layer.

6. The method of claim 1, wherein the porous pellet has a packing factor of 15%-93%.

7. The method of claim 1, further comprising mixing the aluminum powder with a binder prior to said consolidating.

8. The method of claim 1, further comprising removing organic material from the porous pellet by thermal processing.

9. The method of claim 1, wherein said sintering is performed in a reducing atmosphere to control oxidation of the aluminum.

10. The method of claim 1, wherein said sintering is performed in a non-oxidizing atmosphere.

11. The method of claim 1, wherein said sintering is performed with a maximum thermal processing temperature below a melting point of the aluminum powder.

12. The method of claim 1, wherein said sintering is performed with a maximum thermal processing temperature of 280 ºC to 655 ºC.

13. The method of claim 1, wherein said etching increases the surface area by a factor of at least 2.

14. The method of claim 13, wherein said etching increases the surface area by a factor of at least 10.

15. The method of claim 1, wherein said etching comprises electrochemical etching.

16. The method of claim 1, wherein said etching comprises chemical etching.

17. The method of claim 1, wherein said etching comprises a combination of electrochemical and chemical etching.

18. The method of claim 1, wherein said providing the conductive polymer layer comprises dipping the etched porous pellet with the aluminum oxide dielectric layer into conductive polymer precursor.

19. A method of manufacturing an aluminum electrolytic capacitor for a semiconductor device, the method comprising:
consolidating aluminum powder into a porous pellet;
sintering the porous pellet;
etching the porous pellet to increase a surface area thereof;
anodizing the porous pellet to form an aluminum oxide dielectric layer on the etched porous pellet;
providing a conductive polymer layer on the aluminum oxide dielectric layer to form the aluminum electrolytic capacitor having the etched porous pellet as an anode and having the conductive polymer layer as a cathode; and
embedding the aluminum electrolytic capacitor in an interposer or a package substrate of the semiconductor device.

20. A method of manufacturing an aluminum electrolytic capacitor for a semiconductor device, the method comprising:
consolidating aluminum powder into a porous pellet;
sintering the porous pellet;
etching the porous pellet to increase a surface area thereof;
anodizing the porous pellet to form an aluminum oxide dielectric layer on the etched porous pellet;
providing a conductive polymer layer on the aluminum oxide dielectric layer to form the aluminum electrolytic capacitor having the etched porous pellet as an anode and having the conductive polymer layer as a cathode; and
embedding the aluminum electrolytic capacitor in a circuit board.
